(19) United States
(12) Patent Application Publication
(10) Pub. No.: US 2007/0149160 A1
(43) Pub. Date: Jun. 28, 2007

(54) FREQUENCY CONVERSION IN A RECEIVER

(75) Inventors: Chaowen Tseng, Taipei (TW); Wai Lau, i (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTEK, INC., Taipei (TW)

(21) Appl. No.: 11/675,656

(22) Filed: Feb. 16, 2007

Related U.S. Application Data
(63) Continuation-in-part of application No. 10/762,455, filed on Jan. 23, 2004.

(51) Int. Cl. H04B 1/26; H04B 15/00

(52) U.S. Cl. 455/314

(57) ABSTRACT

A method for frequency conversion in a receiver. A signal having a radio frequency and carrying information on a selected channel is received and converted from the radio frequency to a first variable intermediate frequency determined by the selected channel. The signal is further converted from the first variable intermediate frequency to a second variable intermediate frequency determined by the selected channel. The signal is further converted from the second variable intermediate frequency to a constant baseband frequency.

### CROSS-REFERENCE TO RELATED APPLICATIONS

This application is a continuation-in-part application of U.S. Utility application Ser. No. 10/762,455, filed Jan. 23, 2004, and hereby incorporated herein in its entirety by reference.

### BACKGROUND OF THE INVENTION

1. Field of the Invention

The invention relates to frequency conversion and particularly to double or triple conversion of an RF signal in a TV tuner.

2. Description of the Prior Art

Broadband tuners are used in a variety of consumer and commercial systems such as TVs, VCRs and other devices that include cable modems and cable set-top-boxes. More than 300 million broadband tuners are produced every year.

Increased services offered through broadcast TV and cable operators have resulted in a rapidly evolving and convergent market. Incorporation of DVD, VCR, Personal Video Recording, and Internet functionality into TV sets, set-top-boxes, and personal computers is a major goal.

Serving as the RF front-end of broadband signals, the tuner receives available channels, selecting the desired channel and filtering out the others. The tuners, operating at frequencies from 40 to 900 MHz have different performance requirements than traditional TV tuners. Smaller form factors, low power consumption, high reliability and ease of manufacture are important concerns of such tuner applications.

In a TV tuner, frequency conversion architecture is essential to a tuner design.

In U.S. Pat. No. 5,737,035, Robert Rudolf Rotzoll et al. disclose a highly integrated double conversion television tuner on a single microcircuit, as shown in FIG. 1. The RF signal enters a TV tuner 100 from an antenna 402 (or cable, not shown) and passes a RF low-pass filter (RFLPF) 404 to limit the incoming band to below 900 MHz. The filtered RF signal is amplified up to 20 dB by a gain-controlled low-noise transconductance amplifier (LNTA) 406.

The output of a first local oscillator (LO1) 450, operating between 1200 and 2100 MHz and determined by channel selection, is mixed in a first mixer (MIX1) 408 with the RF signal to generate a first IF video carrier frequency of 1200 MHz. The frequency of 1200 MHz is constant, irrespective of the TV channel selected. This approach leads to minimum distortion due to mixer images and harmonic mixing. The first IF is crudely filtered by the bandwidth limitation of the first mixer 408 to minimize harmonic effects.

The first IF signal of 1200 MHz is mixed in a second mixer (MIX2) 410, an image-rejection mixer, with the fixed 1180 MHz reference output of a second local oscillator (LO2) 412 to generate the second IF at 20 MHz visual carrier. Because the RF input signal is lower in frequency than the LO referenced, the mixing of the two signals results in a down conversion of the RF input.

In such a TV tuner, however, the out-of-band channels must be removed by an external RF SAW (surface acoustic wave) filter, which necessitates a highly linear SAW driver consuming considerable power in the tuner chip. Further, the PLL (phase lock loop) circuit generating the oscillation signal for the first mixer operates at a high frequency, which results in spurious output of the first mixer.

### SUMMARY OF THE INVENTION

Embodiments of the invention provide a method for frequency conversion in a receiver. A signal having a radio frequency and carrying information on a selected channel is received and converted from the radio frequency to a first variable intermediate frequency determined by the selected channel. The signal is further converted from the first variable intermediate frequency to a second variable intermediate frequency determined by the selected channel. The signal is further converted from the second variable intermediate frequency to a constant baseband frequency.

Embodiments of the invention further provide a receiver comprising an antenna, first, second, and third local oscillators, and first, second, and third mixers. The antenna receives an RF signal carrying information from a selected channel. The first local oscillator generates a first oscillating signal having a first frequency. The first mixer mixes the RF signal with the first oscillating signal to generate a first intermediate signal. The second local oscillator generates a second oscillating signal having a second frequency. The second mixer mixes the first intermediate signal with the second oscillating signal to generate a second intermediate signal. The third local oscillator generates a third oscillating signal having a third frequency. The third mixer mixes the second intermediate signal with the third oscillating signal to generate a baseband signal. The first, second, and third frequencies are determined by the selected channel.

Embodiments of the invention provide another receiver comprising an antenna, first, second, and third local oscillators, and first, second, and third mixers. The antenna receives an RF signal carrying information from a selected channel. The first local oscillator generates a first oscillating signal having a first frequency. The first mixer mixes the RF signal with the first oscillating signal to generate a first intermediate signal. The second local oscillator generates a second oscillating signal having a second frequency. The second mixer mixes the first intermediate signal with the second oscillating signal to generate a second intermediate signal. The third local oscillator generates a third oscillating signal having a third frequency. The third mixer mixes the second intermediate signal with the third oscillating signal to generate a baseband signal. Frequencies of the first and second intermediate signals are variable and determined by the selected channel.

### BRIEF DESCRIPTION OF THE DRAWINGS

The invention will become more fully understood from the detailed description given hereinbelow and the accompanying drawings, given by way of illustration only and thus not intended to be limitative of the invention.

FIG. 1 is a diagram of a conventional TV tuner.

FIG. 2 is a diagram of a TV tuner according to an embodiment of the invention.

FIG. 3 is a diagram of an oscillator in a TV tuner according to an embodiment of the invention.

FIG. 4 is a diagram of a TV tuner according to another embodiment of the invention.

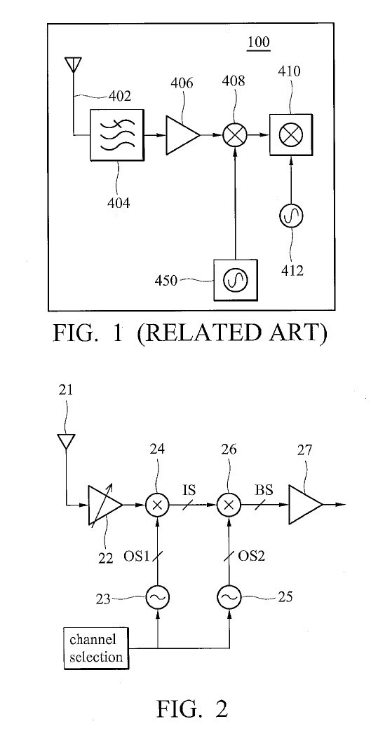

### DETAILED DESCRIPTION OF THE INVENTION

FIG. 2 is a diagram of a TV tuner according to an embodiment of the invention. The TV tuner (receiver) includes an antenna 21 receiving an RF signal carrying information in all TV channels, a low noise amplifier 22 coupled to the antenna 21 to amplify the RF signal, a first local oscillator 23 generating a first oscillating signal OS1 having a first frequency FO1, a first mixer 24 mixing the amplified RF signal with the first oscillating signal OS1 to generate an intermediate signal IS, a second local oscillator 25 generating a second oscillating signal OS2 having a second frequency FO2, a second mixer 26 mixing the intermediate signal IS with the second oscillating signal OS2 to generate a baseband signal BS, and a SAW driver 27 coupled to an output of the second mixer 26 to drive an external SAW filter (not shown). Both frequencies of output oscillating signals OS1 and OS2 are controllable, determined by channel selection, as shown in FIG. 2.

The first local oscillator 23 and mixer 24 form a first frequency conversion stage converting the RF signal from the radio frequency to a variable intermediate frequency IF determined by the selected TV channel. The frequency IF exceeds the radio frequency (up-conversion) and is determined to minimize noise and spurious signals coupled from the other channels into the selected channel. The value of the frequency IF is different for each channel. The second local oscillator 25 and mixer 26 form a second frequency conversion stage converting the signal from the frequency IF to a baseband frequency BF (down-conversion) fixed for all channels. The mixers 24 and 26 are image rejection mixers rejecting in-band noise from the image frequency. The out-of-band signals are rejected by the LC tanks (not shown) inside the mixers 24 and 26.

As first mixer 24 up converts the selected TV channel, IF (the frequency of intermediate signal IS) is equal to the sum of the frequency of the selected TV channel and frequency FO1 of the first oscillating signal OS1 from the first local oscillator 23. Mixer 26 down converts intermediate signal IS, deducting the second frequency FO2 of the second oscillating signal OS2 from frequency IF and resulting in the baseband frequency BF. This frequency correlation, if the frequency of a selected TV channel is defined as TVF, can be expressed as formula (1):
BF=IF−FO2=(FO1+TVF)−FO2 (1)

The last equal sign in formula (1) indicates that the frequency of a selected TV channel, which is variable, as selected by a user, is determined by FO1 and FO2. As BF is a constant and IF is variable, determined by the selected TV channel, the first equal sign indicates that FO2 is also variable, determined by the selected TV channel. In other words, to change a TV channel, both output frequencies, FO1 and FO2, of the two local oscillators are changed, such that IF is also changed and BF remains constant.

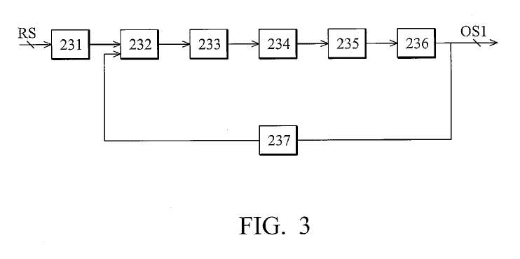

FIG. 3 is a diagram of the oscillator 23. The oscillator includes a first frequency divider 231 dividing a frequency FR of a reference signal RS by a divisor N, a phase frequency detector 232 having a first input coupled to an output of the first frequency divider 231, a charge pump 233 having an input coupled to an output of the phase frequency detector 232, a loop filter 234 having an input coupled to an output of the charge pump 233, a voltage controlled oscillator 235 having an input coupled to an output of the loop filter 234, a second frequency divider 236 dividing a frequency of the signal output from the voltage controlled oscillator 235 by a divisor P and outputting the first oscillating signal OS1, and a frequency multiplier 237 multiplying the first oscillating signal OS1 by a multiplicator M and having an output coupled to a second input of the phase frequency detector 232. The divisors N and P, and the multiplicator M are determined by the selected channel. The frequency FO1 of the first oscillating signal OS1 is derived by:
FO1=FR*M/(P*N)

The operation shown in FIG. 3 is also applicable to the second local oscillator 25 of FIG. 2, the output frequency of which is variable and controllable, determined by channel selection.

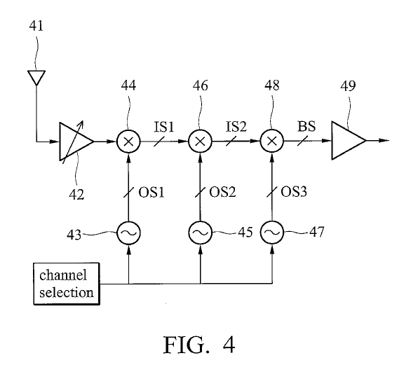

FIG. 4 is a diagram of a TV tuner according to another embodiment of the invention. The TV tuner applies triple conversion rather than double conversion (shown in FIG. 2) to the RF signal. The TV tuner includes an antenna 41 receiving an RF signal carrying information from all TV channels, a low noise amplifier 42 coupled to the antenna 41 to amplify the RF signal, a first local oscillator 43 generating a first oscillating signal OS1 having a first frequency FO1, a first mixer 44 mixing the amplified RF signal with the first oscillating signal OS1 to generate a first intermediate signal IS1, a second local oscillator 45 generating a second oscillating signal OS2 having a second frequency FO2, a second mixer 46 mixing the first intermediate signal IS1 with the second oscillating signal OS2 to generate a second intermediate signal IS2, a third local oscillator 47 generating a third oscillating signal OS3 having a third frequency FO3, a third mixer 48 mixing the second intermediate signal IS2 with the third oscillating signal OS3 to generate a baseband signal BS, and a SAW driver 49 coupled to an output of the third mixer 48 to drive an external SAW filter (not shown). All frequencies of output oscillating signals OS1, OS2 and OS3 are variable and controllable, determined by channel selection.

The first local oscillator 43 and mixer 44 form a first frequency conversion stage converting the RF signal from the radio frequency to a variable intermediate frequency IF1 determined by the selected TV channel. The frequency IF1 exceeds the radio frequency (up-conversion) and is determined to minimize noise and spurious signals coupled from the other channels into the selected channel. The value of the frequency IF1 is different for each channel. The second local oscillator 45 and mixer 46 form a second frequency conversion stage converting the signal from the frequency IF1 to a second intermediate frequency IF2 (down-conversion) which is also variable, determined by the selected TV channel. The third local oscillator 47 and mixer 48 form a third frequency conversion stage converting the signal from the frequency IF2 to a baseband frequency (down-conversion). The mixers 44, 46 and 48 are image rejection mixers rejecting in-band noise from the image frequency. The out-of-band signals are rejected by the LC tanks (not shown) inside the mixers 44, 46 and 48.

Each of the oscillators 43, 45 and 47 can be the same as that shown in FIG. 3. When a channel is selected, the divisors N and P, and the multiplicator M of each oscillator (43, 45 and 47) are simultaneously determined.

It should be noted that the triple conversion tuner shown in FIG. 4 achieves wide-to-narrow band conversion and down-conversion with two mixers 46 and 48, while the double conversion tuner shown in FIG. 2 accomplishes the same down-conversion with a single mixer 26.

In conclusion, the invention provides a TV tuner with fewer elements, lower power consumption, and high signal-to-noise ratio. In comparison with the TV tuner disclosed in U.S. Pat. No. 5,737,035, the TV tuner of the invention provides the advantage of no RF SAW filter, eliminating the need for a highly linear SAW driver and thus reducing power consumption.

Variable intermediate frequencies IF1 and IF2 provides more flexibility in system design over TV tuners having constant intermediate frequencies IF1 and IF2. Another benefit is the ability to avoid undesired in-band mixing products by adjusting IF1 and IF2. In case the mixing products of internal local oscillators fall into the intermediate frequencies IF1 and IF2, both can be changed to other frequencies to avoid the undesired mixing products.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for frequency conversion in a receiver, comprising:
receiving a signal having a radio frequency and carrying information on a selected channel;
converting the signal from the radio frequency to a first variable intermediate frequency determined by the selected channel;
converting the signal from the first variable intermediate frequency to a second variable intermediate frequency determined by the selected channel; and
converting the signal from the second variable intermediate frequency to a constant baseband frequency.

2. The method as claimed in claim 1, wherein the first variable intermediate frequency is determined so that noise coupled from the other channels into the selected channel is minimized.

3. The method as claimed in claim 1, wherein the first variable intermediate frequency exceeds the radio frequency.

4. The method as claimed in claim 1, wherein the second variable intermediate frequency is lower than the first variable intermediate frequency.

5. A receiver comprising:
an antenna receiving an RF signal carrying information from a selected channel;
a first local oscillator generating a first oscillating signal having a first frequency;
a first mixer mixing the RF signal with the first oscillating signal to generate a first intermediate signal;
a second local oscillator generating a second oscillating signal having a second frequency;
a second mixer mixing the first intermediate signal with the second oscillating signal to generate a second intermediate signal;
a third local oscillator generating a third oscillating signal having a third frequency;
a third mixer mixing the second intermediate signal with the third oscillating signal to generate a baseband signal;
wherein the first, second, and third frequencies are determined by the selected channel.

6. The receiver as claimed in claim 5, wherein the frequency of the first intermediate signal is determined so that noise coupled from the other channels into the selected channel is minimized.

7. The receiver as claimed in claim 5, wherein the first oscillator comprises:
a first frequency divider dividing a frequency FR of a reference signal by a divisor N;
a phase frequency detector having a first input coupled to an output of the first frequency divider;
a charge pump having an input coupled to an output of the phase frequency detector;
a loop filter having an input coupled to an output of the charge pump;
a voltage controlled oscillator having an input coupled to an output of the loop filter;
a second frequency divider dividing a frequency of a signal output from the voltage controlled oscillator by a divisor P and outputting the first oscillating signal; and
a frequency multiplier multiplying the first oscillating signal by a multiplicator M and having an output coupled to a second input of the phase frequency detector.

8. The receiver as claimed in claim 7, wherein the divisors N and P, and the multiplicator M are determined by the selected channel.

9. The receiver as claimed in claim 5 further comprising a low noise amplifier coupled between the antenna and the first mixer to amplify the RF signal.

10. The receiver as claimed in claim 5 further comprising a SAW driver coupled to an output of the third mixer.

11. The receiver as claimed in claim 5, wherein the first, second, and third mixers are image rejection mixers.

12. A receiver comprising:
an antenna receiving an RF signal carrying information from a selected channel;
a first local oscillator generating a first oscillating signal having a first frequency;
a first mixer mixing the RF signal with the first oscillating signal to generate a first intermediate signal;
a second local oscillator generating a second oscillating signal having a second frequency;
a second mixer mixing the first intermediate signal with the second oscillating signal to generate a second intermediate signal;
a third local oscillator generating a third oscillating signal having a third frequency; and
a third mixer mixing the second intermediate signal with the third oscillating signal to generate a baseband signal;
wherein frequencies of the first and second intermediate signals are variable and determined by the selected channel.

13. The receiver as claimed in claim 12, wherein the frequency of the first intermediate signal is determined so that noise coupled from the other channels into the selected channel is minimized.

14. The receiver as claimed in claim 12, wherein one of the first, second and third oscillators comprises:
a first frequency divider dividing a frequency FR of a reference signal by a divisor N;
a phase frequency detector having a first input coupled to an output of the first frequency divider;
a charge pump having an input coupled to an output of the phase frequency detector;
a loop filter having an input coupled to an output of the charge pump;
a voltage controlled oscillator having an input coupled to an output of the loop filter;
a second frequency divider dividing a frequency of a signal output from the voltage controlled oscillator by a divisor P and outputting an oscillating signal; and
a frequency multiplier multiplying the oscillating signal by a multiplicator M and having an output coupled to a second input of the phase frequency detector.

15. The receiver as claimed in claim 14, wherein the divisors N and P, and the multiplicator M are determined by the selected channel.

16. The receiver as claimed in claim 12 further comprising a low noise amplifier coupled between the antenna and the first mixer to amplify the RF signal.

17. The receiver as claimed in claim 12 further comprising a SAW driver coupled to an output of the third mixer.

18. The receiver as claimed in claim 12, wherein the first, second, and third mixers are image rejection mixers.
